(19) United States
(12) Patent Application Publication
(10) Pub. No.: US 2013/0291428 A1
(43) Pub. Date: Nov. 7, 2013

(54) FLYSWATTER DEVICE

(71) Applicant: Lucy Wegscheider, Lake Elmo, MN (US)

(72) Inventor: Lucy Wegscheider, Lake Elmo, MN (US)

(21) Appl. No.: 13/461,640

(22) Filed: May 1, 2012

(51) Int. Cl. A01M 3/02

(52) U.S. Cl. 43/137

(57) ABSTRACT

The present invention is a fly swatter device to catch a plurality of bugs and insects that include a traditional fly swatter that includes a handle with a distal end and a planar square surface disposed on the distal end of the planar square surface and a planar sticky surface that is disposed on the planar square surface that is disposable and replaceable. The planar sticky surface is a plurality of layered planar sticky surfaces that are peeled-off and disposed of and expose new planar sticky surfaces to continue catching bugs and insects.

### TECHNICAL FIELD & BACKGROUND

During the warm summer months, some flies may sneak into the home and create a nuisance. Hitting flies with a newspaper or other apparatus may leave behind a mess to clean up. Killing insects and bugs can be a very messy process as well using a traditional fly swatter to kill insects and bugs.

The present invention generally relates to an insect killing device. More specifically, the invention is a fly swatter device.

It is an object of the invention to provide a fly swatter device that catches bugs and various insects with a sticky tape surface disposed on a surface of a traditional fly swatter.

It is an object of the invention to provide a fly swatter device that utilizes a disposable sticky tape surface disposed on a surface of a traditional fly swatter to catch bugs and various insects.

It is an object of the invention to provide a fly swatter device that is cleaner and more sanitary than a traditional fly swatter.

What is really needed is a fly swatter device that catches bugs and various insects with a sticky tape surface disposed on a surface of a traditional fly swatter.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a fly swatter device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

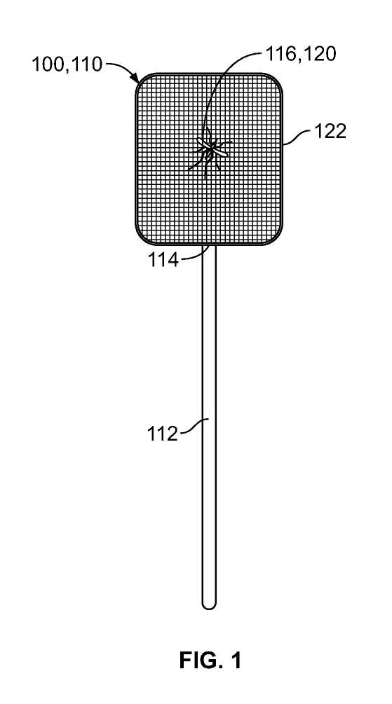

FIG. 1 illustrates a front view of a fly swatter device 100, according to an embodiment of the present invention.

The fly swatter device 100 includes a traditional fly swatter 110 and a planar sticky surface 120. The traditional fly swatter 110 includes a handle 112 with a distal end 114 and a planar square surface 116 disposed on the distal end 114 of the planar square surface 116, although the planar square surface 116 can be any suitable shaped surface such as a rectangle or a circle planar surface. The planar sticky surface 120 is disposed on the planar square surface 116 and is disposable and replaceable. The planar sticky surface 120 is typically a plurality of layered planar sticky surfaces 122 that are peeled-off and disposed of and expose a new planar sticky surface 122 once that peeled-off and disposed planar sticky surface 122 is disposed underneath the peeled-off planar surface 122. A suitable planar sticky surface 120 can be a glue planar sticky surface, fly paper planar sticky surface or any other suitable planar surface.

The fly swatter device is a handheld device for killing insects and bugs. Comprised of a standard fly swatter with a handle, the fly swatter device has a clear sticky tape surface attached to its planar base. To use, simply strike and kill a desired bug or insect and peel away the disposable layer to dispose of in the trash. The replaceable planar sticky surface can be relatively quickly and easily fastened to the planar sticky surface for multiple uses. Homeowners are among many people who may find the fly swatter device both convenient and simple to use. The fly swatter device features a modified insect swatter with a sticky, removable adhesive attached to its planar sticky surface. The fly swatter device is designed to be available in a variety of colors and styles.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A fly swatter device to catch a plurality of bugs and insects, comprising:
a traditional fly swatter that includes a handle with a distal end and a planar square surface disposed on said distal end of said planar square surface; and
a planar sticky surface that is disposed on said planar square surface that is disposable and replaceable.

2. The device according to claim 1, wherein said planar sticky surface is a plurality of layered said planar sticky surfaces.

3. The device according to claim 1, wherein said layered said planar sticky surfaces are peeled-off and disposed of and expose new planar sticky surfaces.

4. The device according to claim 3, wherein said peeled-off and disposed of said planar sticky surfaces are peeled-off and said new planar sticky surface is exposed to catch said bugs and insects.

5. The device according to claim 1, wherein said planar sticky surface is made of tape.

6. The device according to claim 5, wherein said planar sticky surface is made of clear tape.
